(19) United States
(12) Patent Application Publication
(10) Pub. No.: US 2015/0172368 A1
(43) Pub. Date: Jun. 18, 2015

(54) URL MAPPING TO NON-HYPERLINKED CODE

(71) Applicant: Tyfone, Inc., Portland, OR (US)

(72) Inventor: Siva G. Narendra, Portland, OR (US)

(21) Appl. No.: 14/105,776

(22) Filed: Dec. 13, 2013

(51) Int. Cl. H04L 29/08; G06F 17/22

(52) U.S. Cl. CPC H04L 67/10; G06F 17/2247

(57) ABSTRACT

A uniform resource locator (URL) is mapped to a non-hyperlinked human-readable code that is sent to an intended user of a web service using an electronic communication. The intended user enters the non-hyperlinked human-readable code into a website to access the service. The web service may generate the code or a service provider may generate the code. The service provider may also provide inverse mapping logic to map the code back to the URL.

### FIELD

The present invention relates generally to electronic communications, and more specifically to providing hyperlinks in electronic communications.

### BACKGROUND

Electronic communications commonly include hyperlinked content. For example, as shown in FIG. 1, a mobile device 100 may receive a short messaging service (SMS) communication 102 that includes a hyperlink 110. Also for example, as shown in FIG. 2, an electronic mail (email) message 202 may include a hyperlink 210.

Hyperlinks embedded in electronic communications are convenient but present security issues. For example, a nefarious actor may send electronic communications that appear to a recipient as originating from a trusted entity (such as a bank or service provider) when in fact they are not. The electronic communications may include malicious hyperlinks that may be harmful to the recipient's computer or may present a phishing attack by directing the recipient to a webpage mimicking that of the trusted entity.

If a trusted entity routinely sends electronic communications that include bona fide hyperlinks, they may unknowingly desensitize recipients to the threat presented by nefarious actors.

### BRIEF DESCRIPTION OF THE DRAWINGS

FIG. 1 shows a prior art short message service (SMS) communication that includes a hyperlink;

FIG. 2 shows a prior art electronic mail (email) communication that includes a hyperlink;

FIG. 3 shows an SMS communication that includes a non-hyperlinked human-readable code;

FIG. 4 shows an email communication that includes a non-hyperlinked human-readable code;

FIG. 5 shows a webpage to receive a non-hyperlinked human-readable code;

FIG. 6 shows a webpage that is served when a non-hyperlinked human-readable code is entered in the webpage shown in FIG. 5;

FIG. 7 shows operations and communications between a web service and an intended user;

FIG. 8 shows operations and communications between a service provider, a requestor, and an intended user;

FIGS. 9-11 show flowcharts of methods in accordance with various embodiments of the present invention; and

FIGS. 12-13 show webpage to receive a non-hyperlinked human-readable code along with secondary information.

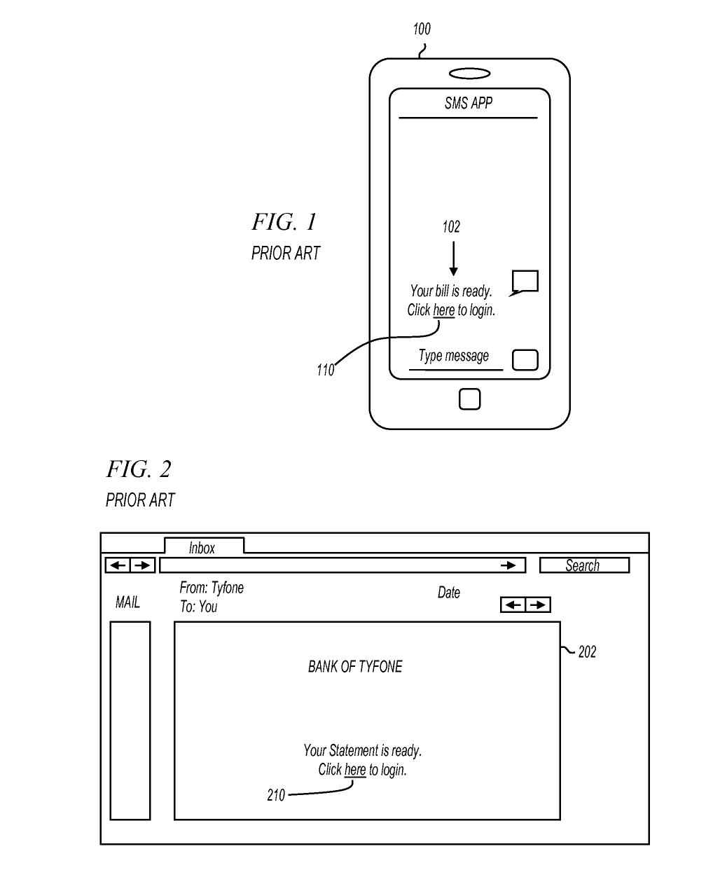

### DESCRIPTION OF EMBODIMENTS

In the following detailed description, reference is made to the accompanying drawings that show, by way of illustration, various embodiments of an invention. These embodiments are described in sufficient detail to enable those skilled in the art to practice the invention. It is to be understood that the various embodiments of the invention, although different, are not necessarily mutually exclusive. For example, a particular feature, structure, or characteristic described in connection with one embodiment may be implemented within other embodiments without departing from the scope of the invention. In addition, it is to be understood that the location or arrangement of individual elements within each disclosed embodiment may be modified without departing from the scope of the invention. The following detailed description is, therefore, not to be taken in a limiting sense, and the scope of the present invention is defined only by the appended claims, appropriately interpreted, along with the full range of equivalents to which the claims are entitled. In the drawings, like numerals refer to the same or similar functionality throughout the several views.

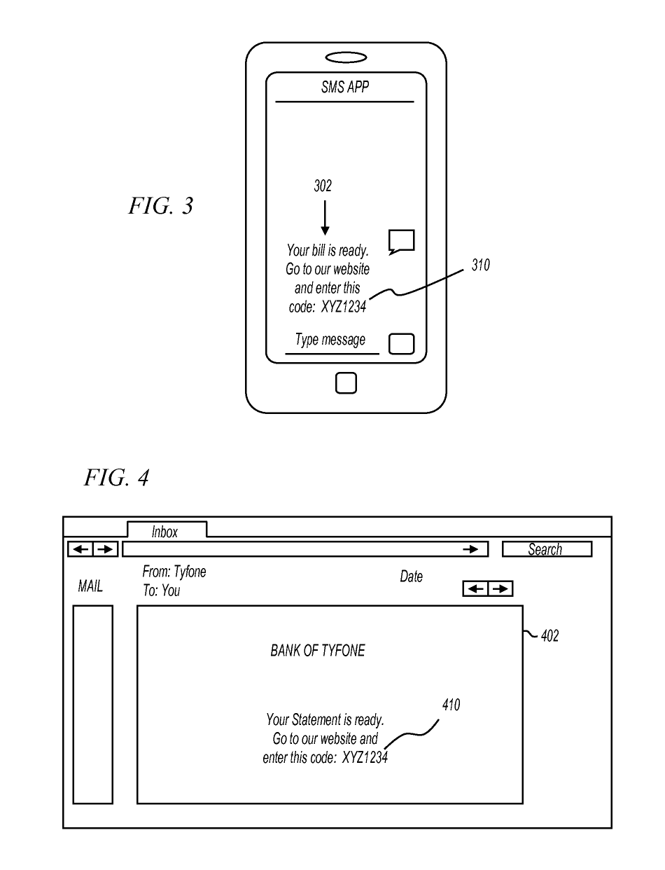

FIG. 3 shows an SMS communication 302 that includes a non-hyperlinked human-readable code 310. In some embodiments, non-hyperlinked human-readable code 310 maps to a uniform resource locator (URL) that will provide a specified service to the recipient of the SMS communication. For example, code 310 may map to a URL for a cable company login page or to a URL for a credit card issuer statement page. In operation, the recipient of the SMS communication is directed to open a web browser and manually navigate to a webpage known to be served by the originator of the SMS communication, and then manually enter code 310. In response, the originator serves a separate webpage that corresponds to the URL, thereby making the web service available to the recipient without requiring the recipient to click on a hyperlink in the SMS communication.

In the example of FIG. 3, the recipient is not required to click on a hyperlink to benefit from the web service provided by the originator. As embodiments of the present invention are practiced over time, recipients will become accustomed to receiving and using non-hyperlinked human readable codes rather clicking directly on hyperlinks in SMS messages. If a nefarious actor sends an SMS communication with a malicious hyperlink, recipients accustomed to receiving non-hyperlinked human-readable codes are less likely to click on the malicious hyperlink, and are therefore less likely to fall prey to the nefarious actor.

FIG. 4 shows an email communication 402 that includes a non-hyperlinked human-readable code 410. Functionally, the scenario shown in FIG. 4 is similar to the scenario shown in FIG. 3, with the exception that the electronic communication is in the form of an email message rather than an SMS message. In operation, an originator sends the email communication 402 to a recipient, and the recipient manually navigates to a known webpage and enters code 410. The originator then provides the web service corresponding to code 410.

As used herein, the term “originator” refers to an entity or computer resource that originates an electronic communication that includes a non-hyperlinked human-readable code. Further, as used herein, the term “recipient” refers to users or computer resources that receive electronic communications that include non-hyperlinked human-readable codes. In some embodiments, an originator may send electronic communications with non-hyperlinked human-readable codes to intended users of a web service provided by the originator. In these embodiments, the term “intended user” is synonymous with the term “recipient,” and the term “originator” is synonymous with the term “web service provider.” In other embodiments, the originator of the electronic communication may be a party other than a web service provider. These and other embodiments are more fully described below.

Neither SMS communication 302 nor email communication 402 include a hyperlink. In these embodiments, a non-hyperlinked human-readable code is sent in the place of a hyperlink. Various embodiments of the invention are not so limited as to require that hyperlinks not be included. For example, in some embodiments, one or more hyperlinks may be included along with the non-hyperlinked human-readable code in order to give the recipient a choice to either click on the hyperlink or to navigate to a known webpage to enter the code. In these embodiments, the recipient may click on the hyperlink or may manually navigate to a known webpage and then enter the non-hyperlinked human readable code as described above.

As used herein, the term “non-hyperlinked” refers to text that does not include an associated URL reference. In some embodiments, non-hyperlinked codes are not only non-hyperlinked as they are placed in electronic communications, but they also take a form that discourages being interpreted as a hyperlink later. For example, a code “XYZ1234” is not likely to be interpreted as a valid URL, and is therefore unlikely to be turned into a hyperlink by a web browser, an SMS app, or other software.

As used herein, the term “human-readable” refers to the ability of a human to read, interpret, and reenter a code. For example, a code “XYZ1234” is human-readable, in part because a human can read the code and reenter it when visiting a website.

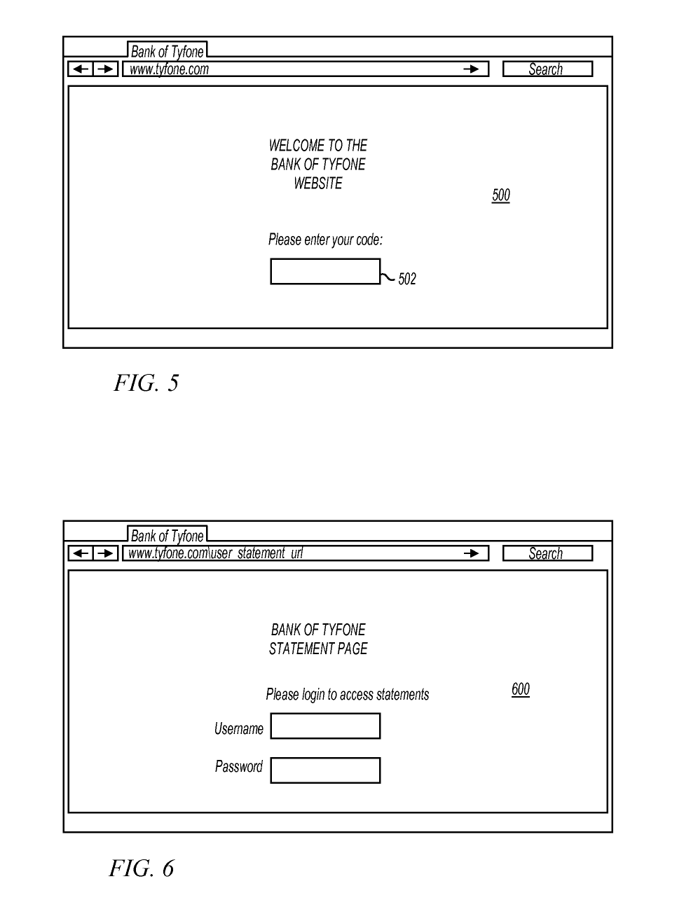

FIG. 5 shows a webpage to receive a non-hyperlinked human-readable code. The webpage 500 shown in FIG. 5 is an example of a known webpage to which a recipient may manually navigate in order to enter a non-hyperlinked human-readable code. In the example of FIG. 5, the web page is known to the recipient because the originator and recipient have an established relationship: that of a bank and its customer. The recipient enters code 410 (FIG. 4) into page 500 at 502, and then the web service provider maps the code to a URL to display the page shown in FIG. 6.

FIG. 6 shows a webpage that is served when a non-hyperlinked human-readable code is entered in the webpage shown in FIG. 5. Web page 600 provides a service to the intended user after the user has entered the non-hyperlinked human-readable code into the page shown in FIG. 5.

FIGS. 4-6 provide an example using a fictitious bank (The Bank of Tyfone) as both the originator and the web service provider. FIG. 4 shows an email originating at the web service provider (The bank of Tyfone) and received by an intended user of the web service. The email includes a non-hyperlinked human-readable code and instructions to manually navigate to the Bank of Tyfone's website to enter the code. In response to receiving the email communication, the intended user manually navigates to www.tyfone.com as shown in FIG. 6. The web page served by the web service provider (The Bank of Tyfone) allows for the entry of the code. When the code is entered, the code is mapped to the web service URL www.tyfone.com/user_statement_url and this separate webpage is served to the intended user as shown in FIG. 6. In this example, the web service provider is a bank, and the web service provides bank statements for viewing.

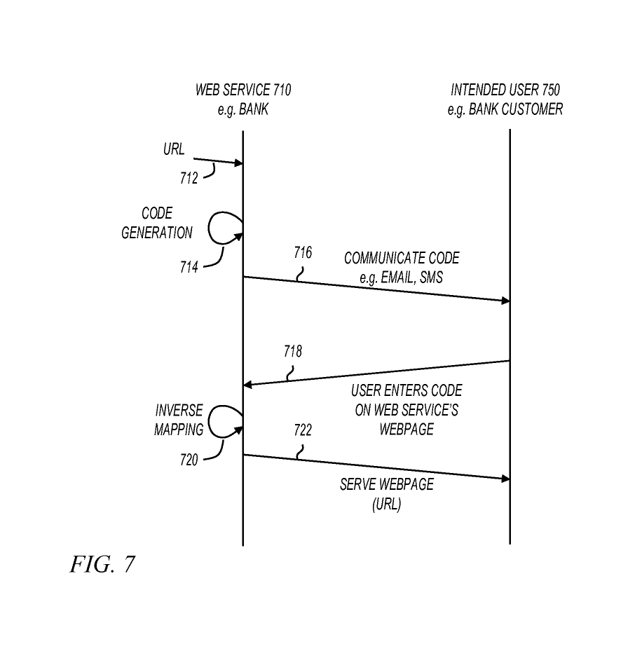

FIG. 7 shows operations and communications between a web service and an intended user. Web service 710 is a service that maps a URL to a code, sends the code to an intended user, receives the code at a first webpage, maps the code back to the URL, and provides a service to the intended user. FIG. 7 continues the example of FIGS. 4-6 in which the web service is a bank and the intended user is a bank customer.

At 712, web service 710 receives (or determines) a URL corresponding to a web page that provides a service to an intended user when the intended user navigates to that page in a browser. An example service might includes providing a bill or statement online, or inviting an intended user to visit a website for another reason. At 714, web service 710 generates a non-hyperlinked human-readable code from the URL. In some embodiments, the code is generated from the URL in combination with additional information (e.g., info identifying the intended user).

Code generation at 714 may be accomplished in any manner. For example, in some embodiments, URLs are mapped to codes using tables, hash functions, encryption, encoding, or the like. An inverse mapping 720 provides the mapping from the code back to the URL, and is generally the inverse of the forward mapping. For example, when a lookup table is used to map the URL to a code at 714, an inverse lookup table is used to map the code to the URL at 720. Also for example, when the URL is encrypted to arrive at the code at 714, the code may be decrypted to arrive at the URL at 720.

In some embodiments, a subset of the URL is encrypted to arrive at the code at 714, and the inverse mapping at 720 is a lookup that maps the encrypted subset of the code back to the code itself. In further embodiments, encryption and/or hashing is combined with a lookup to arrive at the code. For example, a subset of the URL or the entire URL may be encrypted or hashed, and the result may be mapped to the code at 714.

The web service sends the non-hyperlinked human-readable code to the intended user at 716. This may be accomplished using any electronic communications medium, including for example, email or SMS. The electronic communication may include instructions for the intended user to manually navigate to a webpage to enter the code. Examples of electronic communications including a non-hyperlinked human-readable code are shown in FIGS. 3 (SMS) and 4 (email).

At 718, the user enters the non-hyperlinked human-readable code on the web service's webpage. An example webpage for this purpose is shown in FIG. 5. At 720, the web service maps the code back to the URL (inverse mapping), and at 722, the web service serves a web page that is separate from the page in which the user entered the code. The web page served at 722 begins to provide the service intended for the user. An example is shown in FIG. 6.

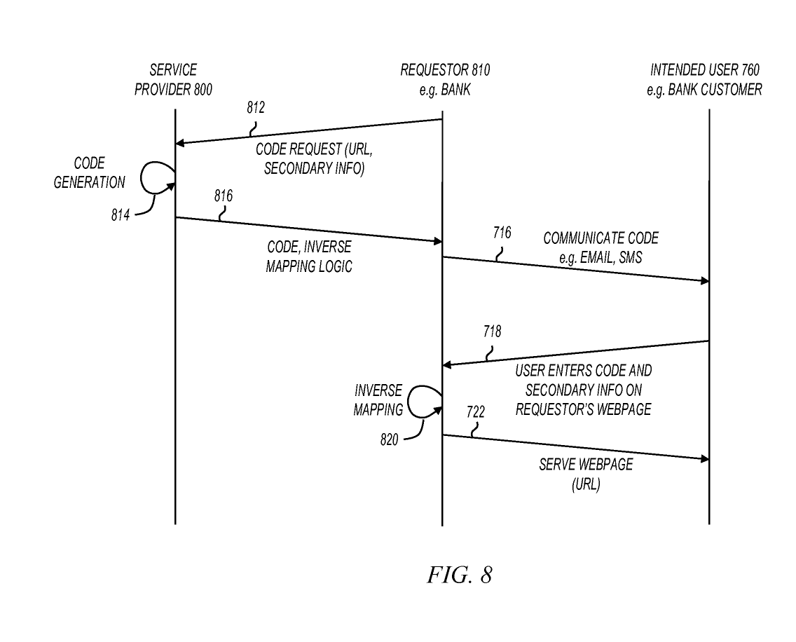

In the example of FIG. 7, all operations and interactions are performed by the combination of the web service and the intended user. In some embodiments, the code generation and inverse mapping is provided by a separate service so each and every web service is not responsible for all mappings between codes and URLs. This is described in more detail with reference to FIG. 8.

FIG. 8 shows operations and communications between a service provider, a requestor, and an intended user. The intended user 760 in FIG. 8 is the same as the intended user 760 in FIG. 6. The requestor 810 in FIG. 8 is the same entity as web service 710 in FIG. 7. Requestor 810 provides the same web service to intended user 760, but is termed a “requestor” because it requests services (e.g., code generation and inverse mapping logic) from service provider 800.

Requestor 810 requests a non-hyperlinked human-readable code from service provider 800 at 812. The request includes the URL and other optional information shown in FIG. 8 as “secondary information.” As used herein, the term “secondary information” refers to any information other than the URL. This information may identify the intended user, or may include data known to the intended user. Examples include answers to challenge questions know by the intended user, the intended user's email address, the intended user's zip code, or the like. When secondary information is utilized in the code generation, this secondary information may be required to be entered by the intended user when the user enters the code in the known website. Examples are described further below with reference to later figures.

The service provider 800 generates the non-hyperlinked human-readable code at 814 in response to the request made by requestor 810. In some embodiments, URLs optionally in combination with secondary information are mapped to codes using tables, hash functions, encryption, encoding, or the like. An inverse mapping 820 provides the mapping from the code back to the URL, and is generally the inverse of the forward mapping. For example, when a lookup table is used to map the URL to a code at 814, an inverse lookup table is used to map the code to the URL at 820. Also for example, when the URL is encrypted to arrive at the code at 814, the code may be decrypted to arrive at the URL at 820.

Service provider 800 provides the code and inverse mapping logic to the requestor 810 at 816. Requestor 810 sends the non-hyperlinked human-readable code to the intended user at 716. This may be accomplished using any electronic communications medium, including for example, email or SMS. The electronic communication may include instructions for the intended user to manually navigate to a webpage to enter the code. Examples of electronic communications including a non-hyperlinked human-readable code are shown in FIGS. 3 (SMS) and 4 (email).

At 718, the user enters the non-hyperlinked human-readable code on the web service's webpage. An example webpage for this purpose is shown in FIG. 5. At 720, the web service maps the code back to the URL (inverse mapping), and at 722, the web service serves a web page that is separate from the page in which the user entered the code. The web page served at 722 begins to provide the service intended for the user. An example is shown in FIG. 6.

The communications shown in FIGS. 7 and 8 may occur between machines or systems across any physical medium. For example, non-hyperlinked human-readable codes may be communicated to intended users using wired network connections, wireless network connections, cellular radio connections, and the like. Further, the various embodiments of the present invention are not limited by the type of number of computers and systems involved. For example, the service provider, web service, and originator functions may be performed by one or more computers connected in a physical network, or may be performed by a single computer that includes multiple virtual machines or virtual servers. Further, an intended user may receive non-hyperlinked human readable codes using a mobile device such as a mobile phone, tablet computer, or laptop computer; or may receive codes on a larger computing device such as a desktop computer. Still further, the intended user may access web services using any platform.

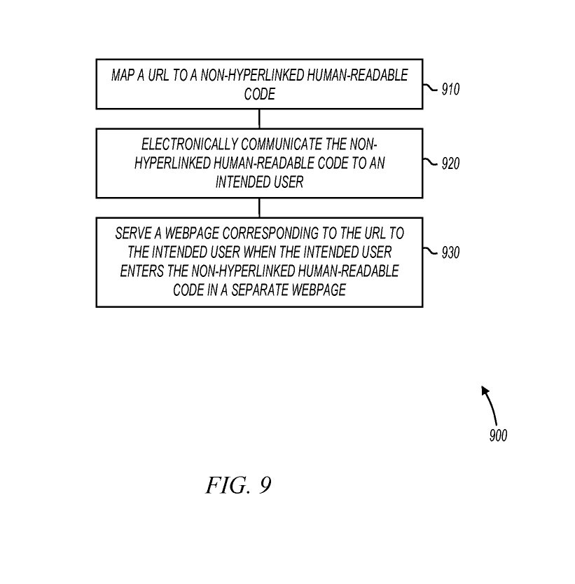

FIG. 9 shows a flowchart of methods in accordance with various embodiments of the present invention. In some embodiments, method 900 is performed by a web service provider in accordance with various embodiments of the present invention. The various actions in method 900 may be performed in the order presented, in a different order, or simultaneously. Further, in some embodiments, some actions listed in FIG. 9 are omitted from method 900.

Method 900 begins at 910 in which a URL is mapped to a non-hyperlinked human-readable code. In some embodiments, the actions of 910 may be performed by a web service provider such as a financial institution (e.g., web service 710, FIG. 7). In other embodiments, the actions of 910 may be performed by a service provider such as service provider 800 (FIG. 8).

The URL may be mapped to the code in any manner. For example, in some embodiments, the URL is encrypted to determine the code, and in other embodiments, a lookup table is used to map the URL to the code. Further, in some embodiments, secondary information used in the process of mapping the URL to the code. For example, information identifying an intended user (e.g., email address or zip code) may be encrypted or hashed along with the URL to determine the code.

At 920, the non-hyperlinked human-readable code is sent electronically to an intended user. In some embodiments, the code is sent using email, and in other embodiments, the code is sent using SMS. The non-hyperlinked human-readable code may be sent using any type of electronic communication without departing from the scope of the present invention. Examples of non-hyperlinked human readable codes are shown in FIGS. 3 and 4.

At 930, a webpage corresponding to the URL is served to the intended user when the intended user enters the non-hyperlinked human-readable code into a separate webpage. For example, the intended user may manually navigate to the separate web page such as page 500 (FIG. 5). When the intended user enters the non-hyperlinked human-readable code on the separate web page, a web page corresponding to the URL is served. For example, web page 600 (FIG. 6) may be served.

In some embodiments, the actions of 930 include mapping the code back to the URL (inverse mapping). This inverse mapping may be performed by decryption, decoding, using a lookup table, or the like. Further, in some embodiments, secondary information may be required from the intended user before the web page corresponding tot the URL is served.

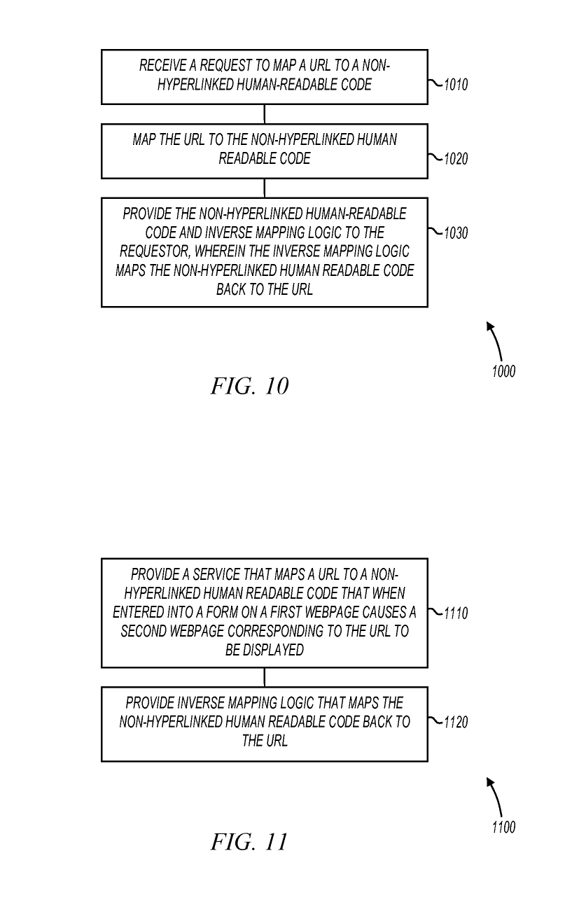

FIG. 10 shows a flowchart of methods in accordance with various embodiments of the present invention. In some embodiments, method 1000 is performed by a service provider in accordance with various embodiments of the present invention. The various actions in method 1000 may be performed in the order presented, in a different order, or simultaneously. Further, in some embodiments, some actions listed in FIG. 10 are omitted from method 1000.

Method 1000 begins at 1010 in which a service provider receives a request to map a URL to a non-hyperlinked human-readable code. In some embodiments, the request is accompanied by at least one identifier of an intended user. In these embodiments, the at least one identifier may be used in the mapping of the URL to the code as described above. At 1020, the URL is mapped to a non-hyperlinked human-readable code using any of the embodiments described herein.

At 1030, the non-hyperlinked human-readable code and inverse mapping logic is provided to the requestor, where the inverse mapping logic maps the non-hyperlinked human-readable code back to the URL. The inverse mapping logic provided to the requestor allows the requestor to perform the inverse mapping when the intended user enters the non-hyperlinked human-readable code. In some embodiments, the inverse mapping logic requires secondary information from the intended user in order to map the code back to the URL.

In some embodiments, a service provider that provides the services described in FIG. 10 is neither an originator nor a web service provider that provides a service to an intended user. Instead, the requestor provides the web service to the intended user. This is shown in FIG. 8 where the service provider that provides the services described in FIG. 10 is service provider 800, and the requestor 810 is the entity that provides web services to the intended user.

A service provider may provide the services described in FIG. 10 to many different requestors in the same or different industries. For example, a single service provider may provide the services described in FIG. 10 to financial services companies, cable providers, utilities, and the like. This allows web service providers in disparate industries to provide a common user experience with respect to non-hyperlinked human-readable codes in electronic communications.

FIG. 11 shows a flowchart of methods in accordance with various embodiments of the present invention. In some embodiments, method 1100 is performed by a service provider in accordance with various embodiments of the present invention. The various actions in method 1100 may be performed in the order presented, in a different order, or simultaneously. Further, in some embodiments, some actions listed in FIG. 11 are omitted from method 1100.

Method 1100 begins at 1110 in which a service is provided that maps a URL to a non-hyperlinked human-readable code that when entered into a form on a first webpage causes a second webpage corresponding to the URL to be displayed. In some embodiments, the actions of 1110 are performed at a service provider such as service provider 800 (FIG. 8). In these embodiments, service provider 800 provides the service and also performs the mapping. In other embodiments, the service of 1110 is provided by supplying an application programming interface (API) to a web service such as web service 710 (FIG. 7). In these embodiments, the service of 1110 is provided by a service provider such as service provider 800 (FIG. 8), and the mapping is provided by a web service such as web service 710 (FIG. 7).

At 1120, inverse mapping logic is provided that maps the non-hyperlinked human-readable code back to the URL. In some embodiments, the inverse mapping logic is provided as part of an API. For example, service provider 800 (FIG. 8) may provide inverse mapping logic to web service 710 (FIG. 7) as part of an API.

In these embodiments, service provider 800 provides the service of 1120, and web service 710 performs the inverse mapping.

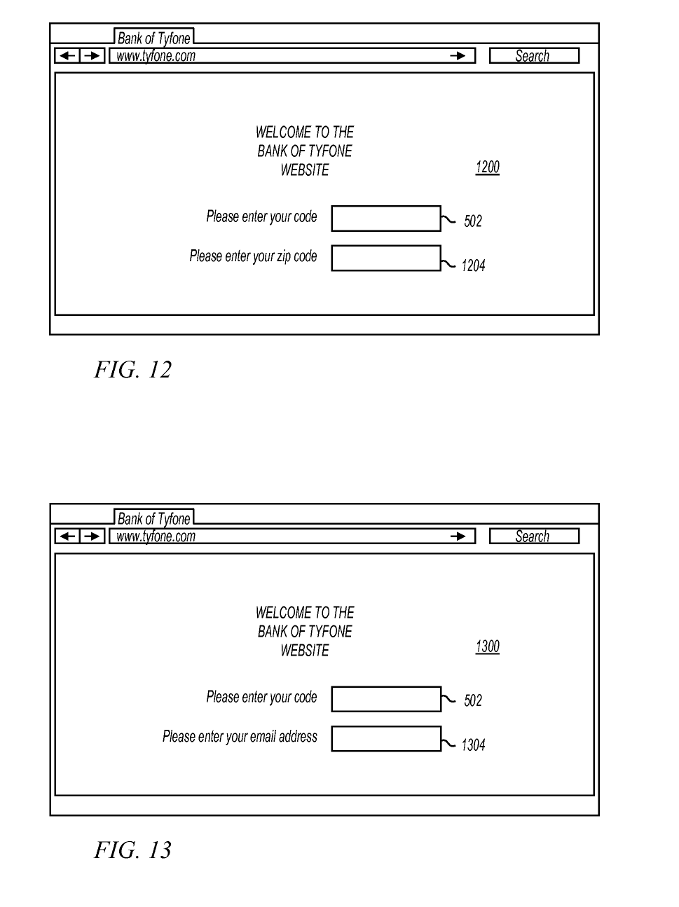

FIGS. 12-13 show webpage to receive a non-hyperlinked human-readable code along with secondary information. Web pages 1200 and 1300 show web pages similar to page 500 (FIG. 5). These are pages that are known to the intended user and are manually navigated to by the intended user after the intended user receives a non-hyperlinked human-readable code. In the example of FIG. 12, page 1200 prompts for the code at 502 as described above with reference to FIG. 5, and also prompts for secondary information. The secondary information may be information that further identifies the intended user such as the intended user's zip code 1204.

In the example of FIG. 13, page 1300 prompts for the code at 502 as described above with reference to FIG. 5, and also prompts for secondary information. The secondary information may be information that further identifies the intended user such as the intended user's email address 1304.

Although the present invention has been described in conjunction with certain embodiments, it is to be understood that modifications and variations may be resorted to without departing from the spirit and scope of the invention as those skilled in the art readily understand. Such modifications and variations are considered to be within the scope of the invention and the appended claims.

What is claimed is:

1. A method comprising:
mapping a uniform resource locator (URL) to a non-hyperlinked human-readable code;
electronically communicating the non-hyperlinked human-readable code to an intended user;
serving a webpage corresponding to the URL to the intended user when the intended user enters the non-hyperlinked human-readable code in a separate webpage.

2. The method of claim 1 wherein mapping the URL to the non-hyperlinked human-readable code comprises encrypting at least a subset the URL

3. The method of claim 2 wherein the separate webpage performs a decryption function to determine the URL.

4. The method of claim 1 wherein mapping the URL to the non-hyperlinked human-readable code comprises using a hash function.

5. The method of claim 1 wherein mapping the URL to the non-hyperlinked human-readable code comprises using a lookup table.

6. The method of claim 1 further comprising requiring the intended user to enter secondary information in addition to non-hyperlinked human-readable code prior to serving the webpage corresponding to the URL.

7. The method of claim 6 wherein the secondary information comprises an email address.

8. The method of claim 6 wherein the secondary information comprises a zip code.

9. The method of claim 1 wherein electronically communicating the non-hyperlinked human-readable code to an intended user comprises emailing the non-hyperlinked human-readable code.

10. The method of claim 1 wherein electronically communicating the non-hyperlinked human-readable code to an intended user comprises sending the non-hyperlinked human-readable code in a short messaging service (SMS) communication.

11. A method comprising:
receiving a request to map a uniform resource locator (URL) to a non-hyperlinked human-readable code;
mapping the URL to the non-hyperlinked human-readable code; and
providing the non-hyperlinked human-readable code and inverse mapping logic to the requestor, wherein the inverse mapping logic maps the non-hyperlinked human-readable code back to the URL.

12. The method of claim 11 wherein mapping comprises encrypting, and the inverse mapping logic comprises decrypting.

13. The method of claim 11 wherein mapping comprises encoding, and the inverse mapping logic comprises decoding.

14. The method of claim 11 wherein mapping comprises performing a hash function, and inverse mapping logic comprises a lookup value.

15. The method of claim 11 further comprising the requestor emailing the non-hyperlinked human-readable code to an intended user.

16. The method of claim 11 further comprising the requestor sending the non-hyperlinked human-readable code to an intended user using a short messaging service (SMS).

17. The method of claim 11 wherein the request includes the URL and at least one identifier corresponding to an intended user of the non-hyperlinked human-readable code.

18. A method comprising:
providing a service that maps a uniform resource locator (URL) to a non-hyperlinked human-readable code that when entered into a form on a first webpage, causes a second webpage corresponding to the URL to be displayed.

19. The method of claim 18 wherein the service maps the URL to the non-hyperlinked code by encrypting the URL.

20. The method of claim 19 wherein the form on the first webpage performs a decryption function to determine the URL.

21. The method of claim 18 wherein the service maps the URL to the non-hyperlinked code using a hash function.

22. The method of claim 18 wherein providing the service further comprises providing inverse mapping logic for use with the first webpage, wherein the inverse mapping logic maps the non-hyperlinked human-readable code back to the URL.
